(19) United States
(12) Patent Application Publication
(10) Pub. No.: US 2003/0046407 A1
(43) Pub. Date: Mar. 6, 2003

(54) Electronic rights management

(76) Inventors: John S. Erickson, Norwich, VT (US); Mark Schlageter, Merrimack, NH (US)

Correspondence Address: HEWLETT-PACKARD COMPANY, P.O. BOX 272400, FORT COLLINS, CO, 80527-2400, US

(21) Appl. No.: 09/941,615

(22) Filed: Aug. 30, 2001

(51) Int. Cl. G06F 15/16; G06F 15/173

(52) U.S. Cl. 709/229; 709/225

(57) ABSTRACT

A proxy service for providing a practical point of intervention for the application of information handling policies, especially copyright management and enforcement services. The invention provides a platform upon which to generalize the interpretation and enforcement of copyright policies, which is particularly useful where large related basis of users with heterogeneous viewing environments might need policies applied in a uniform and flexible way. The invention keeps the process and mechanisms of user authentication and authorization separate and distinct from the actual implementation of policy enforcement.

### FIELD OF THE INVENTION

This invention relates generally to electronic rights management, and in particular, to a flexible platform for supporting rights management schemes and other information handling policies especially for use in information technology networked environments.

### BACKGROUND TO THE INVENTION

Copyright is an intellectual property right which gives rights to the creators of certain kinds of material, so that they can control the various ways in which their material may be exploited. It is intended to protect original literary, dramatic, musical and artistic works, published editions of works, sound recordings, films (including videograms) and broadcasts (including cable and satellite broadcasts), and the rights afforded by copyright broadly cover copying, adapting, issuing copies to the public, performing in public and broadcasting such protected material. In many cases, the author will also have the right to be identified on his work, and object to mutilations and distortions of his work. Further, a rental right is given to owners of copyright in sound recordings, films and computer programs and therefore the exploitation of such works by renting them to the public requires a licence from the copyright owner.

In recent years, it has become increasingly common to store content such as sound recordings, literary works and films electronically, and the commercial distribution of electronic content such as this traditionally takes place through retail outlets, such as record or book shops. Commercial distribution of electronic content over an information technology network has many advantages, but has not yet been widely adopted by creators and commercial distributors of such content, largely because of fears relating to the resultant increase in potential ease with which such content may be illicitly reproduced, sold and distributed by third parties. For this reason, significant effort has been directed toward the development of technological safeguards which prevent unauthorised copying of electronic content.

Digital content is relatively easy to copy illegally, which is both advantageous and disadvantageous for content providers in the sense that on the one hand it is desirable for the content to be distributed as widely as possible (thereby increasing its value and therefore the potential revenues to be gained therefrom), but they still want to ensure that they are paid for each sale, i.e. they do not want piracy taking place. In order to prevent piracy, as stated above, the content providers are inclined towards the use of digital protection schemes (which are normally based on encryption techniques) which are a) difficult to use for consumers and restrict distribution, b) expensive to manage, and c) possibly undercut by free, illegal schemes which provide the same content with an easier user experience.

One known protection scheme is provided by the Microsoft Digital Media System in which electronic content is provided with a key, with a corresponding key being required to be obtained from an authorised key server before the user can play the content. One of the main disadvantages of this scheme is that it is tightly bound to the user's player, in the sense that special equipment is required by the user if they wish to play the content protected by this scheme.

In general, many known digital rights management and protection schemes involve substantial encryption of material, making it difficult to copy, and/or difficult to play copied content. Digital rights management (DRM) technologies in current use make themselves apparent to users either as secure containers, i.e. they define their own proprietary file format, inside of which they securely encapsulate an arbitrary media file.

For example, U.S. Pat. No. 6,138,119 describes techniques for defining, using and manipulating rights management data structures in which the concept of a secure digital container is used for safely and securely storing and transporting digital content. Such containers are tamper-resistant containers which can be used to package any kind of digital information, such as for example, text, graphics, executable software, audio and/or video. However, this approach limits the context in which secured content may be used.

An alternative type of system provides a “plug-in” security function to a particular media format (such as Adobe™ PDF). Although the software plug-in business model has been used successfully for years to extend applications in other specific markets, such as video and audio (pluggable codecs), multimedia (pluggable executables that “extend” programs), creativity tools (filters that extend image processing tools) and Web browsers, currently only Adobe Acrobat™ provides a security function with which third-party developers can uniformly develop DRM systems that operate within a particular format. However, the approach used in this system is limited by the media capabilities of the target format (PDF), i.e. this approach limits, to a single format, the number of media types that may be secured.

Providers, intermediaries and consumers of digital information products suffer from a “policy enforcement disconnect” in that there are no consistent platforms upon which information producers may express their intellectual property rights (IPR) and assert their IPR policies, especially those that specify rules for the handling of their information by intermediaries (e.g. wholesalers, retailers and libraries). There are no consistent platforms for their information to be rendered for users and their policies to be interpreted and enforced. Consumers who are concerned about the transmission and re-use of private data that they may divulge during the course of networked transactions similarly have no consistent platform under their control to enforce their personal information handling policies.

In general, participants in information value chains want to express policies by which they require their information to be handled, as well as policies by which the information they receive to be handled or processed before it gets to them. This problem cannot be solved in a systematic and consistent way using known technology.

The concept of using a proxy service (where ‘proxy’ in it s broadest sense simply means ‘authorisation given to a substitute or deputy’) for the purpose of content filtering and adaptation is known. For example, rule-based filtering for the purposes of stripping web advertisements or other undesirable content is an emerging practice. In particular, U.S. Pat. No. 5,996,011 describes a system and method for restricting access to data received by a computer over a network by filtering certain data from the data received. In one embodiment, a computer-based method is described for filtering objectionable or target text data from World Wide Web pages which are received by a computer system connected to the Internet.

U.S. Pat. No. 6,119,165 describes a system whereby, in an Internet or Intranet environment, a proxy server which supports a number of clients has additional functionality which allows it to deliver a software module to a particular client depending on characteristics of that client. This downloaded module is then executed by the client which sets up a bidirectional communications link between the proxy server and the client. The bidirectional link allows for instance a status display at the client, by use of a window at the client platform, indicating the current status of proxy server activity such as virus scanning, content filtering, bandwidth usage, etc. In other applications, the downloaded module allows provision of an organisational bulletin board, news channel, or provider of common software patches.

U.S. Pat. No. 5,987,606 describes a system for filtering Internet content retrieved from an Internet computer network by a remote Internet Service Provider (ISP) server and forwarded to a local client computer. The system matches at least one filtering scheme, such as an inclusive or exclusive filter, and at least one set of filtering elements, such as a list of allowed or excluded sites, to each Internet request generated at the local client computer. In this case, the filtering scheme is implemented on the ISP server, but in general, these types of filtering and adaptation services may be applied at the client end, the server, or points in between the two. Furthermore, filtering and adaptation need not be limited to down-stream content (i.e. content received by the client platform from the server); proxy services exist that adapt user inputs for the purpose of ensuring privacy and/or anonymity.

However, none of the known proxy services provide practical point of intervention for the application of information handling policies, especially copyright management and enforcement services. In general, as stated above, known mechanisms for enforcing copyright policies have generally required either specialised client side “reader” software that detracts from the end-user's enjoyment of the content, or they use very limited content-dependent policy enforcement functions on the server side, thereby limiting viewable content. Specialised client applications have numerous disadvantages associated with them, ranging from limitations dependent on platform compatibility and/or application compatibility, to user inconvenience. Known server-based systems also have a number of weaknesses, related to issues ranging from administrative granularity to content flexibility.

We have now devised an arrangement which seeks to overcome these problems.

### SUMMARY OF THE INVENTION

Thus, in accordance with a first aspect of the present invention, there is provided apparatus for providing a proxy service between one or more client platforms and one or more remote content providers providing electronic content or information, the apparatus comprising means for receiving and interpreting a request from a client platform for electronic content from a content provider, means for transmitting said request to said content provider and for receiving data including at least one marker identifying the location of a remote information handling and/or policy enforcement server appropriate to the content being requested, means for interpreting said one or more markers and transmitting a request on behalf of said client platform for a clear-content version of said content for transmission to said client platform provided that the requirements of the information handling and/or policy enforcement server are met.

Also in accordance with the first aspect of the present invention, there is provided a method of providing a proxy service between one or more client platforms and one or more remote content servers providing electronic content, the method comprising the steps of receiving and interpreting a request from a client platform for electronic content from a content server, transmitting said request to said content server and for receiving data including at least one marker identifying the location of a remote information handling and/or policy enforcement server appropriate to the content being requested, means for interpreting said one or more markers and transmitting a request on behalf of said client platform for a clear-content version of said content for transmission to said client platform provided that the requirements of said information handling and/or policy enforcement service are met.

In accordance with a second aspect of the present invention, there is provided apparatus for providing a proxy service between one or more client platforms and one or more remote platforms arranged to receive electronic content or information from said one or more client platforms, the apparatus comprising means for receiving data from a client platform for transmission to a remote platform, said data being representative of information or content to be provided to said remote platform and including at least one marker identifying the location of a remote information handling policy enforcement service appropriate to the information being provided, means for interpreting said one or more markers and transmitting a request to the appropriate information handling policy enforcement service for a clear-content version of said information to be provided to said remote location provided that the requirements of said information handling policy enforcement service are met.

Also in accordance with a second aspect of the present invention, there is provided a method for providing a proxy service between one or more client platforms and one or more remote platforms arranged to receive electronic content or information from said one or more client platforms, the method comprising the steps of receiving data from a client platform for transmission to a remote platform, said data being representative of information or content to be provided to said remote platform and including at least one marker identifying the location of a remote information handling policy enforcement service appropriate to the information being provided, interpreting said one or more markers and transmitting a request to the appropriate information handling policy enforcement service for a clear-content version of said information to be provided to said remote location provided that the requirements of said information handling policy enforcement service are met.

Thus, the present invention provides a proxy service which can be used as an intermediary between a client platform and several different content providers having different rights management or information handling policies to ensure that such policies so that the content providers can ensure that their particular policies are enforced. The present invention also provides a proxy service which can be used as an intermediary between a client platform and several different remote locations to which the client platform may wish to send sensitive, private or confidential information, to ensure that the client platform's confidentiality/anonymity policies are upheld. A single proxy service according to the invention may be used to achieve both objectives, i.e. such a service could be arranged to handle data coming from and going to a client platform.

The proxy service may be located locally on the client platform. However, if the ‘client’ comprises an organisational network comprising a plurality of platforms, the proxy service may be located centrally within such a network. Alternatively, the proxy server may be located at a remote point within an information technology network, such as the Internet.

In response to a request for content by the proxy service, the content server returns a data stream including one or more markers including details (such as a URL or DOI) of the location of one or more other services with which the proxy service must interact before a copy of the content can be transmitted to the client platform. Such markers are preferably embedded within the data stream and only recognisable and interpretable by specific means provided within the proxy service.

In transmitting (either directly or indirectly) a request for the content to the remote information handling/rights management server, the proxy service is preferably arranged to include in the request data relating to the client platform, such as the session id in the case where the client platform is a web browser or the like. Thus, the information handling/rights management server is provided with specific details relating to the client platform. The request may also include specific details of the end user, especially in the case that the end user and the client platform are not the same entity and there are no specific requirements related to the information handling/rights management server for interaction between the end user and the client platform.

Once the request for content is received from the proxy service, and the information handling/rights management server has verified the legitimacy of the request, it creates a clear-content version of the content and stores it (preferably temporarily) at a particular location, either locally or remotely, and returns details of said location to the proxy service. The proxy service is preferably arranged to transmit the details of the location at which the clear-content version of the content is stored to the client platform, so that the client platform can retrieve said clear-content copy, if certain requirements of the information handling/rights management server are met.

It will be appreciated that the policies adopted by the information handling/rights management server will be dependent upon the requirements of the content provider and, of course, the nature of the content being requested. It will also be appreciated that the information handling/rights management service may be associated with the client platform or the end user, such that information being transmitted to a remote location from the client platform can be handled by the proxy server and processed through the appropriate information handling service prior to transmission thereof to said remote location.

### BRIEF DESCRIPTION OF THE DRAWINGS

An embodiment of the present invention will now be described by way of example only and with reference to the accompanying drawing which is a schematic flow diagram illustrating the operation of an exemplary embodiment of the present invention.

### DETAILED DESCRIPTION OF THE INVENTION

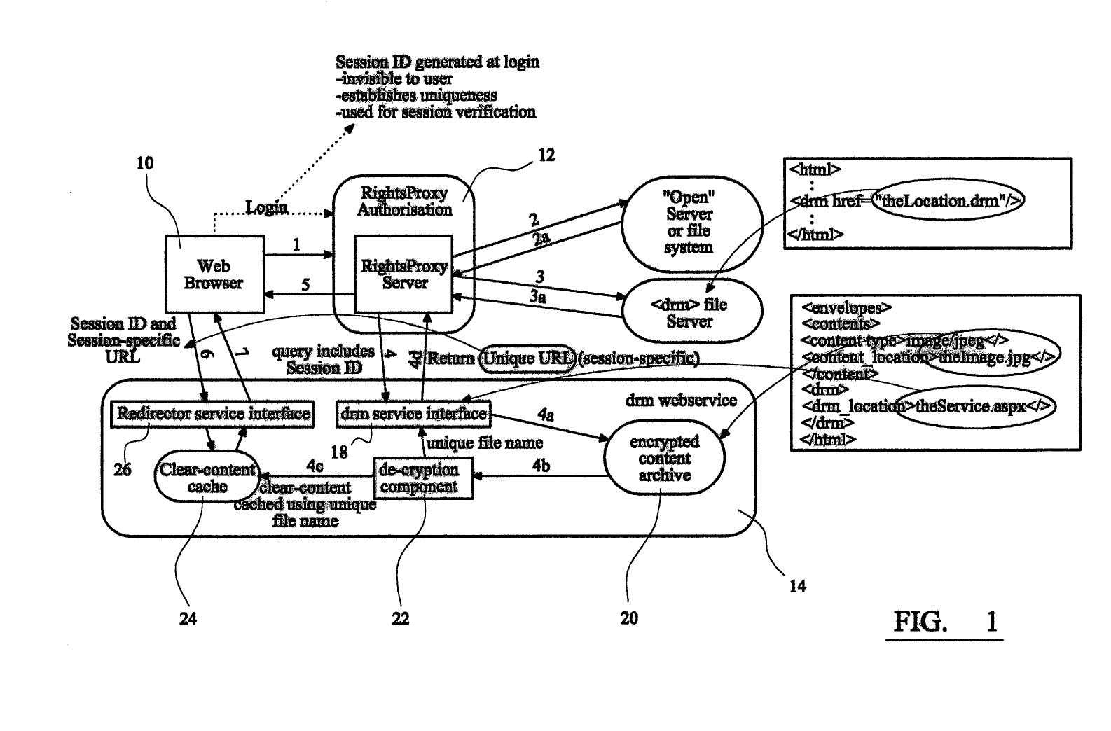

Referring to FIG. 1 of the drawings, there is illustrated a typical set of (potential) connections between a web browser 10 (accessible via a client computer platform—not shown), a proxy server 12 according to the invention, and a digital rights management (DRM) web service 14, the connections typically being made across an information technology network, such as the Internet. The arrows 1, 2, 2a, 3, 3a, 4, 4a, 4b, 4c, 4d, 5, 6 and 7 are directionally illustrative of requests and responses which may be communicated between the web browser 10, the proxy server 12 and the DRM web service 14 in an exemplary process to be described below.

In the first instance, the web browser 10 logs in to the proxy server 12, at which point a unique session ID is generated which is invisible to the end user and which is used for session verification later in the process.

Referring to arrow 1, the viewing client or web browser 10 makes a request of a network resource by presenting the network address (for example, URL or DOI) to the proxy server 12. It will be appreciated that the proxy server 12 may be located locally on the user's workstation, centrally within a corporate or institutional network, or at a distant point on the Internet.

The proxy server 12 sends (via arrow 2) the appropriate network request for the resource to a content server 16, typically by means of the HTTP protocol. The content server 16 (which is typically at a different location to the proxy server 12) returns (via arrow 2a) the resource (e.g. a web page), typically in the form of an HTML file or a more general XML file. Embedded within the resource file are markup tags or the like for calling other resources which can only be retrieved by special processing (according to the information handling policy or digital rights management mechanism provided by the proxy server 12). In this embodiment of the present invention, such markup tags are denoted as <DRM> objects. Such <DRM> object instances within the otherwise “open” data stream being sent to the proxy server 12 have attributes (e.g. URL's or DOI's) which reference other web resources with which the proxy server 12 must interact to obtain the location(s) of clear (i.e. unencrypted) versions of the embedded content objects.

It will be appreciated that the proxy server 12 is adapted to recognise the markup tags embedded in the data stream received from the content server 16. If the web browser 10 were to attempt to retrieve the data stream directly from the content server 16, without first passing through the proxy server 12, it would only be able to recognise the “open” portion of the stream, it would not be able to recognise or interpret the markup tags (i.e. thse would be ignored by the web browser 10).

As the proxy server 12 receives the resource data stream from the content server 16, it passes the incoming stream according to a set of generated rules to discover the one or more markup tags embedded in the data stream. The proxy server 12 is adapted to extract from the tag body the property pointing to the location of, for example, a “drm file” which is located at a distant point on the Internet. The proxy server 12 then requests (arrow 3) and receives (arrow 3a) the designated <DRM> file(s), which may use, for example, the XML syntax. The proxy server 12 extracts from this file the “content_type” and “content_location” (a URL, for example) of the actual content object (which is typically packaged in a secure container or the like).

The service interprets the content_type, which typically uses “MIME”encoding (e.g. image/jpeg), and compares the content_type against one or more content_types registered with the proxy service. If the content_type is one of the registered types with the service, it determines a “clear” tag structure which will be passed back to the end user. For example, if the packaged content is of MIME type image/jpeg, the modified tag structure must be in the format “<img src=‘. . . ’>”. In other words, if the resource is permitted to be made available to the end user (as a registered or licenced user, say), then the proxy server 12 will proceed as follows.

The proxy server 12 then requests (arrow 4) that the remote DRM web service 14 create a session-specific, “clear-content” version of the designated resource, and return the session-unique URL. In more detail, the drm service interface 18 locates (via arrow 4a) the encrypted version of the <drm> file held in an encrypted content archive 20 within the drm web service 14. The content archive 20 then sends the encrypted <drm> file to a de-cryption component 22, again located within the drm web service 14. The de-cryption component 22 decrypts the file to produce a “clear-content” version thereof, which clear-content version is transmitted to (via arrow 4c) and cached using a session-specific (temporary) unique file name in a clear-content cache 24, once again located within the drm web service 14. The unique file name is also sent to the drm service interface 18 which generates a session-specific URL of the unsecured resource for transmission (via arrow 4d) to the proxy server 12.

The proxy server 12 generates a modified content stream (for example, an HTML page) using (in this case) MIME-appropriate formatting, the HTML page being reformatted to identify the unique, session-specific URL supplied by the drm web service 14. The reformatted HTML page is then returned (arrow 5) to the web browser 10.

The web browser 10 then requests (arrow 6) the unsecured content held in the clear-content cache 24 via a redirector service interface 26 within the drm web service 14, the browser's request comprising a query string including the session-specific URL, which should only be valid during the current browser session. The redirector service interface 26 determines the current browser session and compares it with the session-specific URL included in the query string sent by the browser 10. If the session matches, and any timeout rules on the temporary storage of the cleared content have not expired, the redirector service interface 26 sends the clear content to the web browser 10 for use by the end user.

It will be appreciated that the present invention builds on emerging concepts of proxy-based intervention and content adaptation and provides a platform upon which to generalise the interpretation and enforcement of information handling and digital rights management policies, which is particularly useful in portal-like scenarios, where large related bases of users with heterogeneous viewing environments might need policies applied in uniform and flexible ways. In other words, the present invention enables the homogeneous application of information handling policies (such as copyright enforcement policies) in user-specific ways on heterogeneous institutional networks.

The approach adopted by the present invention essentially keeps the process and mechanisms of user authentication and authorisation separate and distinct from the actual implementation of policy enforcement. This allows organisations or content services to leverage centrally-managed enterprise databases for the administration of information policies (e.g. organisational site licences to electronic journals, especially in the case where different policies are to be applied to different roles within the organisation).

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Apparatus for providing a proxy service between one or more client platforms and one or more remote content providers providing electronic content or information, the apparatus comprising means for receiving and interpreting a request from a client platform for electronic content from a content provider, means for transmitting said request to said content provider and for receiving data including at least one marker identifying the location of a remote information handling and/or policy enforcement server appropriate to the content being requested, means for interpreting said one or more markers and transmitting a request on behalf of said client platform for a clear-content version of said content for transmission to said client platform provided that the requirements of the information handling and/or policy enforcement server are met.

2. Apparatus for providing a proxy service between one or more client platforms and one or more remote platforms arranged to receive electronic content or information from said one or more client platforms, the apparatus comprising means for receiving data from the client platform for transmission to a remote platform, said data being representative of the information or content to be provided to said remote platform and including at least one marker identifying the location of a remote information handling policy enforcement service appropriate to the information being provided, means for interpreting said one or more markers and transmitting a request to the appropriate information handling policy enforcement service for a clear-content version of said information to be provided to said remote location provided that the requirements of said information handling policy enforcement service are met.

3. Apparatus according to claim 1, wherein in response to a request for content for the proxy service, the content server returns a data stream including one or more markers including details of the location of one or more other services with which the proxy service must interact before a copy of the content can be transmitted to the client platform.

4. Apparatus according to claim 3, wherein the markers are preferably embedded within the data stream and only recognisable and interpretable by specific means provided within the proxy service.

5. Apparatus according to claim 1, wherein in transmitting a request for the content to the remote information handling/rights management server, the proxy service is arranged to include in the request data relating to the client platform, such as the session ID in the case where the client platform is a web browser of the like.

6. Apparatus according to claim 1, wherein one the request for content is received from the proxy service, and the information handling/rights management server has verified the legitimacy of the request, it creates a clear-content version of the content and stores it at a particular location, either locally or remotely and returns details of said location to the proxy service.

7. Apparatus according to claim 6, wherein said clear-content version of the content is stored temporarily.

8. Apparatus according to claim 6, wherein the proxy service in arranged to transmit the details of the location of which the clear-content version of the content is stored to the client platform, so that the client platform can retrieve said clear-content copy, if certain requirements of the information handling/rights management server are met.

9. A method of providing a proxy service between one or more client platforms and one or more remote content servers providing electronic content, the method comprising the steps of receiving and interpreting a request from a client platform for electronic content from a content server, transmitting said request to said content server and for receiving data including at least one marker identifying the location of a remote information handling and/or policy enforcement server appropriate to the content being requested, means for interpreting said one or more markers and transmitting a request on behalf of said client platform for a clear-content version of said content for transmission to said client platform provided that the requirements of said information handling and/or policy enforcement service are met.

10. A method for providing a proxy service between one or more client platforms and one or more remote platforms arranged to receive electronic content or information from said one or more client platforms, the method comprising the steps of receiving data from a client platform for transmission to a remote platform, said data being representative of information or content to be provided to said remote platform and including at least one marker identifying the location of a remote information handling policy enforcement service appropriate to the information being provided, interpreting said one or more markers and transmitting a request to the appropriate information handling policy enforcement service for a clear-content version of said information to be provided to said remote location provided that the requirements of said information handling policy enforcement service are met.
